(19) United States
(12) Patent Application Publication
(10) Pub. No.: US 2018/0297450 A1
(43) Pub. Date: Oct. 18, 2018

(54) HIGH-VOLTAGE VEHICLE HEATER AND METHOD FOR USING RECUPERATION POWER IN A VEHICLE

(71) Applicant: Webasto SE, Stockforf (DE)

(72) Inventors: JOSEPH SCHRIEK, Stockdorf (DE); GERD FRITSCH, Stockdorf (DE); KARL GÖTTL, Stockford (DE)

(21) Appl. No.: 15/767,505

(22) PCT Filed: Sep. 30, 2016
(86) PCT No.: PCT/EP2016/073496

§ 371 Date: Apr. 11, 2018

(30) Foreign Application Priority Data
Oct. 13, 2015 (DE) 10 2015 013 301.2

(51) Int. Cl. B60H 1/22; B60H 1/00

(52) U.S. Cl. CPC B60H 1/2218; B60H 1/2225; B60H 1/00385; B60H 2001/2265; B60H 2001/224; B60H 2001/2253; B60H 2001/2231

(57) ABSTRACT

The invention relates to a high-voltage vehicle heater (10), comprising a control device (12), comprising an electrical heating element (14) which is intended for heating a heating medium (16), and comprising a first data interface (18) by means of which a heating request signal can be received, said heating request signal representing an external heating request, wherein the control device (12) determines a first data set which represents at least one first electrical power with which the electrical heating element is to be operated in order to meet the external heating request, wherein the control device (12) determines, on the basis of a parameter data set, a second data set which represents at least one second electrical power which can be supplied to the electrical heating element (14) in addition to the first electrical power, without there being a risk of the vehicle heater (10) being damaged.

The invention relates to a high-voltage vehicle heater having a control device, having an electrical heating element which is provided for heating a heating medium and having a first data interface via which a heating request signal, representing an external heating request, can be received, wherein the control device determines a first data set which represents at least one first electrical power level with which the electrical heating element is to be operated in order to meet the external heating request.

Furthermore, the invention relates to a method for using recuperation power in a vehicle which has a recuperator, a battery and an electrical high-voltage vehicle heater, in which excess recuperation power is fed to the vehicle heater, which cannot be taken up, or is not to be taken up, by the battery.

It has already been repeatedly proposed to use energy recovered by recuperation to operate various electrical loads, in particular in operating states in which the vehicle battery cannot or is not to completely take up the available power.

For example, DE 10 2007 017 021 A1 discloses, for the purpose of recovery of the kinetic and/or potential energy in hybrid vehicles, in particular in plug-in hybrid vehicles with high internal resistance values of the traction battery, routing the energy recovered by means of the recuperation via one or more connections, running parallel with the traction battery, from the electric machine directly to high-voltage electrical consumers, as a result of which the charge losses which are caused by the high internal resistance of the fully charged traction battery are reduced, and the efficiency level of the recuperation is improved. According to the teaching of this document, when there are high internal resistance values of the traction battery, recuperated energy is therefore fed directly via the connection, running parallel to the traction battery, of the electric machine and selected high-power electrical consumers, such as, for example, electrical heating modules in the water circuit or oil circuit. The control or monitoring of the activation/deactivation of direct electrical connections between large electrical consumers and the electric machine takes place during recuperation using efficiency values for the charging or discharging of the battery and for the electric machine by means of a separate and/or a hybrid control device and/or by control devices of other electrical consumers, in particular large consumers. In this context it is proposed to provide that artificial intelligence methods, such as neural networks and/or fuzzy logics, are applied.

The problem which occurs in conjunction with recuperation is that peak power levels of, for example, up to 27 kW can be made available by the recuperation, while commercially available high-voltage vehicle heaters are for example configured only for continuous output levels of 5 to 7 kW. If a significantly higher power level is fed to such high-voltage vehicle heaters, damage can occur to the vehicle heater, or in the worst case there can even be an early failure of the device.

The invention is therefore based on the object of developing the high-voltage vehicle heaters of the generic type and the method of the generic type for the use of recuperation power in a vehicle in such a way that damage or destruction of the high-voltage vehicle heater as a result of an excessively high recuperation power level being fed in can be ruled out, but nevertheless as much energy which can be recovered by recuperation is to be used.

This object is achieved by means of the features of the independent claims. Advantageous refinements and developments of the invention arise from the dependent claims.

In conjunction with the high-voltage vehicle heater according to the invention, this object is achieved in that the control device determines, on the basis of a parameter data set, a second data set which represents at least one second electrical power level which can be fed to the electrical heating element in addition to the first electrical power level, without the risk of damage to the vehicle heater. This solution is based on the realization that the electrical power which can be additionally taken up by the vehicle heater and at which there is no risk of damage to the vehicle heater is not constant, but rather fluctuates as a function of various parameters such as, for example, the operating state and/or age of the vehicle heater, wherein it is certainly possible to feed, on a temporary basis, more power to the vehicle heater than the maximum continuous power level which is provided, without the risk of damage.

In preferred embodiments of the high-voltage vehicle heater according to the invention there is provision that the second data set is output via the first data interface and/or a further data interface. Therefore, the vehicle heater can inform, for example, a recuperation controller, continuously or at intervals about which additional power said vehicle heater would be able to take up at that time. This information can be used by the recuperation controller, for example, to determine how much available kinetic and/or potential energy can be converted into electrical energy by means of recuperation, and how much energy which is possibly available in excess of this is to be converted into heat by the conventional vehicle brakes.

In this context it may also be advantageous if it is provided that the second data set contains information on how long the second electrical power level can be expected to be supplied to the electrical heating element. If the electrical power level which can be additionally taken up by the vehicle heater decreases, for example, as the temperature of the heating medium rises, the control device can predict the profile of the electrical power which can be additionally taken up, on the basis of suitable characteristic curves or calculation algorithms. Therefore, for example a recuperation controller can dynamically implement a requested vehicle deceleration by dynamically adapting the recuperated energy to the electrical power which can be additionally taken up by the battery and by the vehicle heater.

In conjunction with the high-voltage vehicle heater according to the invention it may also be advantageous that a recuperation signal, which indicates that the vehicle in which the vehicle heater is installed is in a recuperation mode, can be fed to the high-voltage vehicle heater via the first data interface and/or via a further data interface. This solution is for example advantageous, without being restricted thereto, if the electrical power which is fed to the vehicle heater from the outside is not regulated and it is included within the range of responsibility of the vehicle heater to avoid an excessively high power consumption independently, for example by reducing a supply voltage applied to the vehicle heater to a suitable amount by means of pulse width modulation.

As already mentioned above, the electrical power which can be additionally taken up by the vehicle heater or by the electrical heating element depends on a large number of variables, for which reason one or more of the following values are taken into consideration for the parameter set used for the power calculation:
volume flow of the heating medium
inlet temperature of the heating medium
outlet temperature of the heating medium
temperature of a shunt which is used to measure the electrical current flowing through the electrical heating element
temperature of an electronic switch used for pulse width modulation of a supply voltage
electrical resistance of the electrical heating element
gradient of the inlet temperature of the heating medium
gradient of the outlet temperature of the heating medium
gradient of the temperature of a shunt which is used to measure the electrical current flowing through the electrical heating element
gradient of the temperature of an electronic switch which is used for pulse width modulation of a supply voltage
gradient of the electrical resistance of the electrical heating element
number of start/stop cycles which the vehicle heater has run through
heating power level which the vehicle heater has provided
heating duration of the vehicle heater
heating gradient
supply voltage
number of faults detected by the vehicle heater up to now
type of faults detected by the vehicle heater up to now.

Although basically air is also possible as a heating medium, water or mixtures of water and anti-frost agent or also oil are also particularly suitable as a heating medium.

With respect to the first group of values mentioned above, which ends with the gradient into the electrical resistance of the electrical heating element, it is to be noted that this primarily comprises current state variables.

The subsequent second group of values is aimed more at the operating circumstances which have occurred since the first activation, that is to say therefore at the previous life of the vehicle heater. As a result, a correlation between damaging factors and the possible or predicated maximum peak heating power or average heating power should be established. Depending on the collected operational data, the control device is to predefine the corresponding power limits to the vehicle heater using stored algorithms. In this context, in particular the service life objective of the vehicle heater can be taken into account. Taken into account in this way can, under certain circumstances, also give rise to a pronounced limitation of the electrical power which can be additionally taken up at the end of the service life of the vehicle heater.

The method according to the invention builds on the generic prior art in that it is determined how much additional recuperation power can additionally be taken up by the vehicle heater at present without the risk of damage to the vehicle heater. This also makes it possible to optimize the recuperation operation and at the same time to rule out damage to the vehicle heater. Reference is correspondingly made to the statements which apply analogously in this context in relation to the high-voltage vehicle heater according to the invention, and this also applies to the points made below.

In the method according to the invention there can be provision that the recuperation power which is taken up by the vehicle heater is limited, either by the vehicle heater or already upstream of the vehicle heater, to the additional recuperation power which the vehicle heater can additionally take up without the risk of damage to the vehicle heater. Therefore, consideration is given both to solutions in which the vehicle heater itself has all the necessary means to be able to reliably avoid it being damaged as well as solutions in which these means are provided on the vehicle side, which may be necessary, for example, if high-voltage vehicle heaters according to the prior art are used. Mixed forms of these two solutions are, of course, also conceivable. For example, the currently possible or predicated maximum peak heating power or average heating power of the vehicle heater can be calculated and signaled to the vehicle energy management system. This in turn can supply the vehicle heater with current system surroundings data and call the desired heating power from the vehicle heater in an accurately timed fashion.

In the method in question, there can also be provision that the determined additional recuperation power which the vehicle heater can additionally take up at present without the risk of damage to the vehicle heater is taken into account during control of the recuperator. As a result, it is possible, for example, to apportion the conversion of kinetic and/or potential energy necessary for a requested deceleration of the vehicle between the recuperator and the vehicle brake in an optimum way. Optimum is to be understood here as meaning that as much energy is always recuperated as can be used appropriately at the moment.

In preferred embodiments of the method according to the invention there is provision that the determination of the additional recuperation power which can additionally be taken up by the vehicle heater at present without the risk of damage to the vehicle heater includes one or more of the following values:
volume flow of the heating medium
inlet temperature of the heating medium
outlet temperature of the heating medium
temperature of a shunt which is used to measure the electrical current flowing through the electrical heating element
temperature of an electronic switch which is used for pulse width modulation of a supply voltage
electrical resistance of the electrical heating element
gradient of the inlet temperature of the heating medium
gradient of the outlet temperature of the heating medium
gradient of the temperature of a shunt which is used to measure the electrical current flowing through the electrical heating element
gradient of the temperature of an electronic switch which is used for pulse width modulation of a supply voltage
gradient of the electrical resistance of the electrical heating element
number of start/stop cycles which the vehicle heater (10) has run through
heating power which the vehicle heater (10) has provided
heating duration of the vehicle heater (10)
heating gradient
supply voltage
number of faults detected by the vehicle heater (10) up until now
type of faults detected by the vehicle heater (10) up until now

Reference is made once more expressly to the relevant statements in conjunction with the high-voltage vehicle heater according to the invention.

Optimum results can be achieved if a high-voltage vehicle heater according to the invention is used to carry out the method according to the invention.

The high-voltage vehicle heater according to the invention and the method according to the invention are explained in more detail below with reference to the drawing, in which:

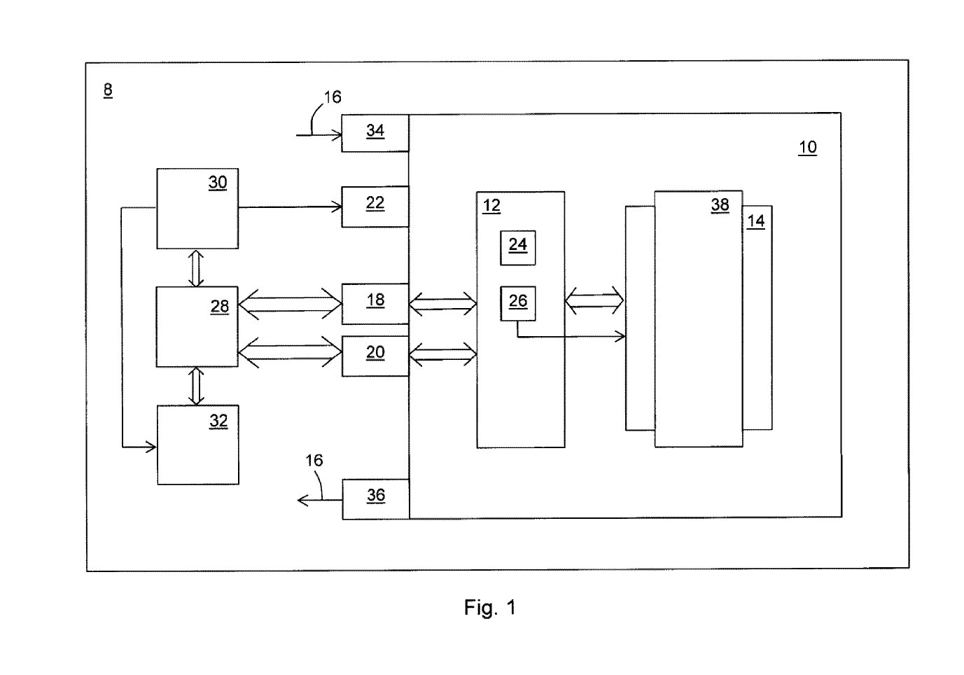

FIG. 1 shows a block circuit diagram of a vehicle which is equipped with the high-voltage vehicle heater according to the invention and in which the method according to the invention can be carried out.

As presented, a vehicle 8 has a high-voltage vehicle heater 10, a recuperator 30, a recuperation controller 28 and a battery 32. The vehicle heater 10 comprises a control device 12, which is assigned a shunt 24 for measuring the current flowing through an electrical heating element 14, and an electronic switch 26, for example in the form of an IGBTs, for pulse width modulation of a voltage which is applied to the supply voltage terminal 22. A heat exchanger 38 is connected in a manner not illustrated to a heating medium inlet 34 and a heating medium outlet 36. In the illustrated case, a mixture of water and anti-frost agent is used as the heating medium 16, as is well known in conjunction with vehicle heaters. The vehicle heater 10 has a first data interface 18 and a second data interface 20, via which it is possible to communicate with the control device 12. The data interfaces 18, 20 can be, for example, CAN or LIN bus terminals. FIG. 1 illustrates only the communication between the data interfaces 18, 20 and the recuperation controller 28. However, it is clear that communication also occurs additionally via the interfaces 18, 20 with other vehicle components, for example with the operator control parts of the vehicle heater or with other controllers of the vehicle.

During operation, the vehicle heater 10 receives, via the first data interface 20, a heating request signal which depends, for example, on a target temperature which has been input by a vehicle occupant. On the basis of this heating request signal, the control device 12 determines a first data set which represents at least a first electrical power level with which the electrical heating element 14 is to be operated in order to meet the external heating request.

In parallel or pseudo-parallel the control device 12 determines, on the basis of a parameter data set, a second data set which represents at least a second electrical power level which can be fed to the electrical heating element 14 in addition to the first electrical power level, without there being the risk of damage to the vehicle heater 10. The parameter data set which is used for this purpose can contain, for example, one or more or the following values: volume flow of the heating medium 16, inlet temperature of the heating medium 16, outlet temperature of the heating medium 16, temperature of a shunt 24 which is used to measure the electrical current flowing through the electrical heating element 14, the temperature of an electronic switch 26 which is used for pulse width modulation of a supply voltage, an electrical resistance of the electrical heating element 14, the gradient of the inlet temperature of the heating medium 16, the gradient of the outlet temperature of the heating medium 16, the gradient of the temperature of a shunt 24 which is used to measure the electrical current flowing through the electrical heating element 14, the gradient of the temperature of an electronic switch 26 which is used for pulse width modulation of a supply voltage, the gradient of the electrical resistance of the electrical heating element 14, the number of the start/stop cycles which the vehicle heater 10 has run through, the heating power which the vehicle heater 10 has provided, the heating duration of the vehicle heater 10, the heating gradient, the supply voltage, the number of faults which have been detected by the vehicle heater 10 up until now, the type of faults which have been detected by the vehicle heater 10 until now. In order to detect the value or values, the vehicle heater 10 comprises one or more suitable sensors, wherein such sensors are well known to a person skilled in the art and are therefore not illustrated in the FIGURE. For example, suitable evaluation circuits, which as such are also well known, can be provided, for example, for determining gradients. Values which are connected to the previous life of the vehicle heater 10 are received, for example, via a non-volatile storage element which is a component of the control device 12.

The second data set, which represents at least the second electrical power which can be fed to the electrical heating element 14 in addition to the first electrical power without the risk of damage to the vehicle heater 10 is communicated to the recuperation controller 28 via the first data interface 18 and/or the second data interface 20. Of course, the second data set can contain further information, for example about how long the second electrical power can be expected to be fed to the electrical heating element 14 and/or possible peak power levels and/or suitable average power levels. The recuperation controller 28 can then take into account this second data set during the determination of the optimum recuperation power, wherein, of course, further parameters are to be taken into account, for example instantaneous internal resistance of the battery 32. It is possible that the recuperation controller 28 feeds to the vehicle heater 10, via the first data interface 18 and/or via the second data interface 20, a recuperation signal which indicates that the vehicle 8 is in a recuperation mode. In this context, if appropriate further information can, of course, be transmitted, for example the level of the electrical power which is to be additionally fed to the electrical heating element 14, which is appropriate, in particular, when this additional power which is to be actually taken up by the electrical heating element 14 is lower than the second electrical power which has been determined by the control device 12.

With respect to the method according to the invention it is, as explained above, on the one hand conceivable that the vehicle heater 10 has the intelligence to determine how much additional recuperation power can additionally be taken up at present by the vehicle heater 10 without there being a risk of damage to the vehicle heater 10. However, it is also conceivable that the intelligence which is necessary for this purpose is provided at another location, for example at the recuperation controller 28 or another controller of the vehicle 8. It is also conceivable that the value or values of the parameter set which are used for the calculation are at least to a certain extent not detected by the vehicle heater 10 but rather externally, for example by means of sensors which are arranged in the water circuit of the vehicle 8 and/or at another suitable location. In a similar way, it is possible with respect to the method according to the invention that the recuperation power which is taken up by the vehicle heater 10 is limited, either by the vehicle heater 10 or already upstream of the vehicle heater 10, to the additional recuperation power which the vehicle heater 10 can additionally take up at a particular time without the risk of damage. If the vehicle heater 10 is responsible for the limitation of the power, the voltage which is applied to the electrical heating element 14 can be subjected to suitable pulse width modulation using the electronic switch 26. If the limitation of the power is already provided upstream of the vehicle heater 10, it must be ensured through suitable measures that the voltage which is applied to the voltage supply terminal 22 of the vehicle heater 10 does not assume excessively high values. Within the scope of the method it is also preferred that the recuperation controller 28 takes into account the determined additional recuperation power during the control of the recuperator 30. Therefore, precisely the quantity of kinetic and/or potential energy which can be appropriately used in the vehicle at a particular time can be converted into electrical energy by recuperation. Possibly present additional energy can then be converted into heat by the conventional vehicle brakes.

The features of the invention which are disclosed in the description above, in the drawings and in the claims can be essential to the implementation of the invention either individually or else in any desired combination.

### LIST OF REFERENCE NUMBERS

8 Vehicle
10 Vehicle heater
12 Control device
14 Heating element
16 Heating medium
18 Data interface
20 Data interface
22 Supply voltage terminal
24 Shunt
26 Switch
28 Recuperation controller
30 Recuperator
32 Battery
34 Heating medium inlet
36 Heating medium outlet
38 Heat exchanger

1. A high-voltage vehicle heater, having a control device, having an electrical heating element which is provided for heating a heating medium, and having a first data interface via which a heating request signal, representing an external heating request, can be received, wherein the control device determines a first data set which represents at least one first electrical power level with which the electrical heating element is to be operated in order to meet the external heating request, wherein the control device determines, on the basis of a parameter data set, a second data set which represents at least one second electrical power level which can be fed to the electrical heating element in addition to the first electrical power level, without the risk of damage to the vehicle heater.

2. The high-voltage vehicle heater as claimed in claim 1, wherein the second data set is output via the first data interface and/or a further data interface.

3. The high-voltage vehicle heater as claimed in claim 1, wherein the second data set contains information on how long the second electrical power level can be expected to be supplied to the electrical heating element.

4. The high-voltage vehicle heater as claimed in claim 1, wherein a recuperation signal, which indicates that the vehicle in which the vehicle heater is installed is in a recuperation mode, can be fed to said high-voltage vehicle heater via the first data interface and/or via a further data interface.

5. The high-voltage vehicle heater as claimed in claim 1, wherein the parameter data set comprises one or more of the following values:
volume flow of the heating medium
inlet temperature of the heating medium
outlet temperature of the heating medium
temperature of a shunt which is used to measure the electrical current flowing through the electrical heating element
temperature of an electronic switch used for pulse width modulation of a supply voltage
electrical resistance of the electrical heating element
gradient of the inlet temperature of the heating medium
gradient of the outlet temperature of the heating medium
gradient of the temperature of a shunt which is used to measure the electrical current flowing through the electrical heating element
gradient of the temperature of an electronic switch which is used for pulse width modulation of a supply voltage
gradient of the electrical resistance of the electrical heating element
number of start/stop cycles which the vehicle heater has run through
heating power level which the vehicle heater has provided
heating duration of the vehicle heater
heating gradient
supply voltage
number of faults detected by the vehicle heater up to now
type of faults detected by the vehicle heater up to now

6. A method for using recuperation power in a vehicle which has a recuperator, a battery and an electrical high-voltage vehicle heater, in which excess recuperation power is fed to the vehicle heater, which cannot be taken up, or is not to be taken up, by the battery, wherein it is determined how much additional recuperation power can at present be additionally taken up by the vehicle heater, without the risk of the vehicle heater being damaged.

7. The method as claimed in claim 6, wherein the recuperation power which is taken up by the vehicle heater is limited, either by the vehicle heater or already upstream of the vehicle heater, to the additional recuperation power which the vehicle heater can additionally take up without the risk of damage to the vehicle heater.

8. The method as claimed in claim 6, wherein the determined additional recuperation power which the vehicle heater can additionally take up at present without the risk of damage to the vehicle heater is taken into account during control of the recuperator.

9. The method as claimed in claim 5, wherein the determination of the additional recuperation power which can additionally be taken up by the vehicle heater at present without the risk of damage to the vehicle heater includes one or more of the following values:
volume flow of the heating medium
inlet temperature of the heating medium
outlet temperature of the heating medium
temperature of a shunt which is used to measure the electrical current flowing through the electrical heating element
temperature of an electronic switch which is used for pulse width modulation of a supply voltage
electrical resistance of the electrical heating element
gradient of the inlet temperature of the heating medium
gradient of the outlet temperature of the heating medium
gradient of the temperature of a shunt which is used to measure the electrical current flowing through the electrical heating element
gradient of the temperature of an electronic switch which is used for pulse width modulation of a supply voltage
gradient of the electrical resistance of the electrical heating element
number of start/stop cycles which the vehicle heater has run through
heating power which the vehicle heater has provided
heating duration of the vehicle heater
heating gradient
supply voltage
number of faults detected by the vehicle heater up until now
type of faults detected by the vehicle heater up until now

10. The method as claimed in claim 6, wherein a high-voltage vehicle heater is used as the vehicle heater.
